(19) United States
(12) Patent Application Publication
(10) Pub. No.: US 2007/0039592 A1
(43) Pub. Date: Feb. 22, 2007

(54) Arrangement with an injection valve and a sleeve as pressure transfer means

(76) Inventor: Eberhard Kull, (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/595,154

(22) PCT Filed: Sep. 3, 2004
(86) PCT No.: PCT/EP04/52024

§ 371 Date: Mar. 7, 2006

(30) Foreign Application Priority Data
Sep. 8, 2003 (DE) 10341335.9

(51) Int. Cl. F02M 61/14; G01M 15/08

(52) U.S. Cl. 123/470; 73/35.12

(57) ABSTRACT

An arrangement with an injection valve (7) is disclosed, arranged in a cylinder head (1) and which permits the recording of the pressure in the combustion chamber (21) of an internal combustion engine (22). A pressure sensor (16) is thus provided, mounted on the injection valve (7). A sleeve (13) is provided as pressure transfer means, enclosing a nozzle body (8) of the injection valve (7), the upper end of which rests on the pressure sensor (16). The lower end of the sleeve (13) runs in a drilling (2) in the cylinder head (22) as far as the region of the end of the drilling (2). A pressure change in the combustion chamber (21) is transmitted to the sleeve (13) by the lower end (14) of the sleeve (13), in the form of a annular surface and transmitted to the pressure sensor (16), by means of the sleeve (13). The embodiment of the sleeve (13) permits an economical and simply produced pressure transfer means.

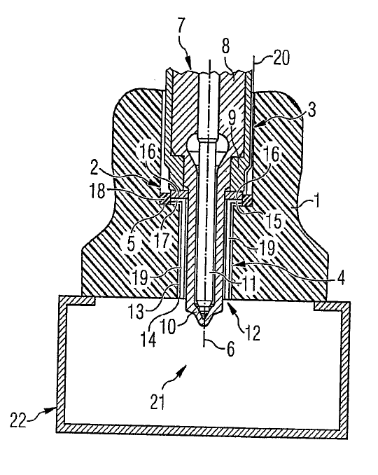

### CROSS-REFERENCE TO RELATED APPLICATIONS

This application is a U.S. national stage application of International Application No. PCT/EP2004/052024 filed Sep. 3, 2004, which designates the United States of America, and claims priority to German application number DE 103 41 335.9 filed Sep. 8, 2003, the contents of which are hereby incorporated by reference in their entirety.

### TECHNICAL FIELD

The invention relates to an arrangement with an injection valve.

### BACKGROUND

The replacement of a glow plug by a pressure sensor to measure the pressure in a combustion chamber of diesel engines is already known. This embodiment has the disadvantage however that the method for recording the combustion chamber pressure can usually only be employed in test bed engines.

An injection valve-pressure sensor combination is known from DE 198 27 287 A1 which is suitable for direct injection of fuel into the combustion chamber of an internal combustion engine and for measuring the pressure in the combustion chamber by means of a piezoelectric element. The piezoelectric element forms an interference fit connection with a valve closure body. The valve closure body acts in conjunction with a valve seat surface to form a sealing seat. Furthermore an electronic activation and control circuit is provided which controls the piezoelectric element during a fuel injection phase so that the valve closing body activated by the latter lifts off the valve seat surface and opens the sealing seat. During a pressure measurement phase the activation and evaluation circuit records a pressure of the combustion chamber transferred from the valve closure body to the piezoelectric element and converted by the latter into an electrical signal.

The embodiment of the fuel injection valve-pressure sensor combination is relatively complicated and expensive.

### SUMMARY

The object of the present invention is to provide an improved arrangement for an injection valve to record pressure in a combustion chamber of an internal combustion engine.

The object of the invention can be achieved by an arrangement with an injection valve comprising a nozzle body, which is disposed in a hole drilled in a cylinder head of an internal combustion engine, wherein the hole opens out into a combustion chamber of the internal combustion engine, wherein a bearing surface of the injection valve is pretensioned against a bearing surface of the cylinder head and the hole is sealed, wherein the nozzle body is disposed between the sealed bearing surfaces and the combustion chamber, and wherein a sleeve is arranged between the nozzle body and the cylinder head in the hole, a pressure sensor is mounted in the hole and the sleeve is provided as a means of translation between the pressure in the combustion chamber and the pressure sensor.

A lower end of the sleeve can be assigned to the combustion chamber, an upper end of the sleeve may lie against the pressure sensor, and the sleeve can be disposed to allow movement in the hole. The pressure sensor can be retained on the injection valve and the upper end can be embodied in the form of an annular flange, the flange can be disposed between an annular surface of the cylinder head and the pressure sensor. The pressure sensor can be surrounded by a sealing ring, and the sealing ring can be tensioned between the injection valve and the cylinder head and seals the hole. The pressure sensor may feature a piezoelectric sensor element. The sleeve can be guided into the edge area of the hole adjoining the combustion chamber. The sleeve can be covered at least partly on its outer and/or inner surface by a coating which makes contamination more difficult. The sleeve can be covered at least partly on its outer and/or inner surface by a coating which reduces friction. The pressure sensor may have an annular form and surrounds the nozzle body.

The arrangement has the advantage that the pressure of the combustion chamber can be precisely recorded using simple means. This is achieved by arranging a sleeve between the nozzle body of the injection valve and the cylinder head, which is intended as a means of transferring the pressure between the combustion chamber and the pressure sensor. Embodying a sleeve as a means of transmission is cost effective and as result of the sleeve form allows easy fitting between cylindrical nozzle body and the cylindrical wall of the hole drilled in the cylinder head.

In a preferred embodiment a front end of the sleeve is assigned to the combustion chamber and a rear end of the sleeve lies against the pressure sensor. The pressure sensor is supported on the cylinder head or the injection valve and the sleeve is arranged to allow movement.

In a further preferred embodiment the rear end of the sleeve is embodied in the form of a flange with an annular surface. The flange is arranged between an annular step of the cylinder head and the pressure sensor. The embodiment of the flange provides a relatively large pressure surface, with which the pressure of the combustion chamber is able be transferred via the sleeve to the pressure sensor. In a preferred embodiment the pressure sensor is embodied in the form of a ring which surrounds the nozzle body.

In a further preferred embodiment the pressure sensor is surrounded by a sealing ring which is clamped between the injection valve and the cylinder head. In this way the hole can be sealed in a simple and secure manner.

In a preferred embodiment the pressure sensor is embodied in the form of a piezoelectric sensor.

Preferably the sleeve is guided as far as the edge area of the hole adjoining the combustion chamber. The position adjoining the chamber enables a change of pressure in the combustion chamber to be recorded without attenuation. This makes it possible to record the pressure change precisely.

In a preferred embodiment the outer surface and/or the inner surface of the sleeve is covered by a protective or lubricating layer. The provision of a protective layer enables the wear and contamination of the sleeve to be reduced. This ensures that the sleeve is still mounted in a manner enabling it move in the hole even after a long period of operation of the internal combustion engine. The provision of a lubricant layer reduces friction during installation of the sleeve on the nozzle body or the cylinder head, so that a change in pressure is recorded precisely.

### BRIEF DESCRIPTION OF THE DRAWINGS

The invention will be explained in greater detail below with reference to the FIGURE.

The FIGURE shows a part section through a fuel injection valve.

### DETAILED DESCRIPTION

The FIGURE shows a part section through a fuel injection valve 7 with a nozzle body which is clamped into a cylinder head 1. The cylinder head 1 features a stepped drilled hole 2, the lower opening of which in the assembled state of the cylinder head 1 is assigned to a combustion chamber 21 of an internal combustion engine 22. The hole 2 has an upper section 3 and a lower section 4. The upper and lower hole sections 3, 4 are essentially embodied as cylindrical in shape and arranged centered symmetrically along a central axis 6. The upper section of the hole 3 passes via an annular surface 5 into the lower section 4, of which the diameter is smaller than the diameter of the upper section 3. The annular surface 5 is essentially disposed at right angles to the center axis 6. The injection valve 7 is only shown in the form of a lower part section and features a nozzle body 8 which is screwed into a housing of the injection valve 7 not shown in the drawing by means of a clamping nut 9. The injection valve 7 has a multi-step shape which tapers in the direction of a nozzle tip 10. Injection holes are embodied in the nozzle tip 10. An injection needle 11 is guided in the nozzle body 8, the tip of said needle acting in conjunction with a sealing seat and, depending on the position of the injection needle 11, enabling fuel to be injected through the injection holes. The functioning and the design of injection valve 7 are sufficiently known and are therefore not explained in any greater detail. The nozzle body 8, starting from the upper hole section 3, protrudes downwards with a nozzle tip 10 via the lower hole section 4 out of the hole 2 of the cylinder head 1. The nozzle tip 10 in the assembled state of the cylinder head 1 thus protrudes into the combustion chamber 21 of an internal combustion engine. An annular area 12 is embodied between the nozzle tip 10 and the cylinder head 1, in the lower section of the hole 4, in which a sleeve 13 is arranged. The lower end 14 of the sleeve 13 is assigned to the combustion chamber 21 and the upper end 15 to a pressure sensor 16. In the embodiment shown the pressure sensor 16 is arranged in the upper section of the hole 3. The pressure sensor 16 is preferably embodied as an annular design and surrounds the nozzle tip 10. The pressure sensor 16 is disposed between annular surface 5 and the injection valve 7, in the embodiment shown between the annular surface 5 and the clamping nut 9. In a simple embodiment the upper end 15 of the sleeve 13 is embodied as a cylinder section which lies against the pressure sensor 16. An advantageous embodiment is shown in the FIGURE, in which the upper end 15 of the sleeve 13 is embodied as an annular flange. The annular flange 17 is disposed between the annular surface 5 and the pressure sensor 16. The flange 15, starting from the annular area 12, extends to beyond the annular surface 5 and thus ensures that the sleeve 13 is held in the cylinder head 1. The flange 17 prevents the sleeve 13 falling into the combustion chamber 21. In the simple embodiment, in which the upper end 15 of the sleeve 13 is embodied as a section of a cylinder, the upper end 15 features other retaining means, for example in the form of a lug or of an edge, with which the sleeve 13 is held on the cylinder head 1 and is prevented from falling down into the combustion chamber 21. Alternatively the sleeve can also be glued onto the pressure sensor.

A sealing ring 18, which is clamped between the annular surface 5 of the cylinder head 1 and the injection valve 7 is provided for sealing of the hole 2 upwards. The sealing ring 18 surrounds the pressure sensor 16. The injection valve 1 is pretensioned via tensioning means not shown in the diagram against the sealing ring 18. The combustion chamber 21 is sealed by the sealing ring 18.

Depending on the embodiment, the sleeve 13 is either longer or shorter in the direction of the combustion chamber. Preferably the sleeve 13 has a coating 19 on its outer side or its inner side. The coating 19 is preferably embodied as a PFTE layer. The coating 19 is used to avoid contamination reaching the surface of the sleeve and/or to reduce friction between sleeve and the nozzle body or between the sleeve and the cylinder head. Other suitable coatings can also be used instead of the PFTE coating.

The pressure sensor 16 preferably features a piezoelectric element which is embodied as a force measurement element, and is suitable for recording pressure in the combustion chamber. The pressure in the combustion chamber 21 is transmitted via the lower end 14, which is embodied as an annular edge, to the sleeve 13 and thus to the pressure sensor 16. The pressure sensor 16 is preferably retained on the injection valve 7. If the pressure in the combustion chamber 21 and thereby the force on the lower end 14 of the sleeve 13 changes, the pressure sensor 16 records this pressure change and forwards a corresponding signal via lines 20 to a control unit. The lines 20 are for example routed upwards out of the cylinder head 1 between the injection valve 7 and the cylinder head 1. To this end the lines 20 are routed between the sealing ring 18 and the injection valve 7 upwards out of the hole 2.

Depending on the embodiment, the lower end 14 can also be arranged so that it is set back by a defined distance in relation to the lower end of the hole 2. In this way the danger of a contamination of the sleeve 13 is reduced, but changes in pressure are no longer recorded so precisely because of the set back position of the lower end 14.

The sleeve is made of steel for example. An air gap is embodied in each case between the sleeve 13 and the nozzle body 8 or between the sleeve 13 and the cylinder head, so that a frictionless movement of the sleeve 13 is possible.

What is claimed is:

1. An arrangement with an injection valve comprising a nozzle body, which is disposed in a hole drilled in a cylinder head of an internal combustion engine, wherein the hole opens out into a combustion chamber of the internal combustion engine, wherein a bearing surface of the injection valve is pretensioned against a bearing surface of the cylinder head and the hole is sealed, wherein the nozzle body is disposed between the sealed bearing surfaces and the combustion chamber,
and wherein a sleeve is arranged between the nozzle body and the cylinder head in the hole, a pressure sensor is mounted in the hole and the sleeve is provided as a means of translation between the pressure in the combustion chamber and the pressure sensor.

2. An arrangement in accordance with claim 1, wherein a lower end of the sleeve is assigned to the combustion chamber, an upper end of the sleeve lies against the pressure sensor, and wherein the sleeve is disposed to allow movement in the hole.

3. An arrangement in accordance with claim 2, wherein the pressure sensor is retained on the injection valve and the upper end is embodied in the form of an annular flange, the flange is disposed between an annular surface of the cylinder head and the pressure sensor.

4. An arrangement in accordance with claim 3, wherein the pressure sensor is surrounded by a sealing ring, and the sealing ring is tensioned between the injection valve and the cylinder head and seals the hole.

5. An arrangement in accordance with claim 1, wherein the pressure sensor features a piezoelectric sensor element.

6. An arrangement in accordance with claim 1, wherein the sleeve is guided into the edge area of the hole adjoining the combustion chamber.

7. An arrangement in accordance with claim 1, wherein the sleeve is covered at least partly on its outer and/or inner surface by a coating which makes contamination more difficult.

8. An arrangement in accordance with claim 1, wherein the sleeve (13) is covered at least partly on its outer and/or inner surface by a coating which reduces friction.

9. An arrangement in accordance with claim 1, wherein the pressure sensor has an annular form and surrounds the nozzle body.

10. An injection valve comprising
a nozzle body, which is disposed in a hole drilled in a cylinder head of an internal combustion engine,
a bearing surface of the injection valve being pretensioned against a bearing surface of the cylinder head in such a way that the hole is sealed, wherein the nozzle body is disposed between the sealed bearing surfaces and the combustion chamber,
a sleeve arranged between the nozzle body and the cylinder head in the hole, and
a pressure sensor mounted in the hole, wherein the sleeve is provided as a means of translation between the pressure in the combustion chamber and the pressure sensor.

11. An arrangement in accordance with claim 10, wherein a lower end of the sleeve is assigned to the combustion chamber, an upper end of the sleeve lies against the pressure sensor, and wherein the sleeve is disposed to allow movement in the hole.

12. An arrangement in accordance with claim 11, wherein the pressure sensor is retained on the injection valve and the upper end is embodied in the form of an annular flange, the flange is disposed between an annular surface of the cylinder head and the pressure sensor.

13. An arrangement in accordance with claim 10, wherein the pressure sensor is surrounded by a sealing ring, and the sealing ring is tensioned between the injection valve and the cylinder head and seals the hole.

14. An arrangement in accordance with claim 10, wherein the pressure sensor features a piezoelectric sensor element.

15. An arrangement in accordance with claim 10, wherein the sleeve is guided into the edge area of the hole adjoining the combustion chamber.

16. An arrangement in accordance with claim 10, wherein the sleeve is covered at least partly on its outer and/or inner surface by a coating which makes contamination more difficult.

17. An arrangement in accordance with claim 10, wherein the sleeve is covered at least partly on its outer and/or inner surface by a coating which reduces friction.

18. An arrangement in accordance with claim 10, wherein the pressure sensor has an annular form and surrounds the nozzle body.
